(19) United States
(12) Patent Application Publication
(10) Pub. No.: US 2015/0293797 A1
(43) Pub. Date: Oct. 15, 2015

(54) METHODS AND SYSTEMS FOR KEY VALUE OBSERVING

(71) Applicant: Chall Fry, Portland, OR (US)

(72) Inventor: Chall Fry, Portland, OR (US)

(21) Appl. No.: 14/686,659

(22) Filed: Apr. 14, 2015

Related U.S. Application Data
(60) Provisional application No. 61/979,279, filed on Apr. 14, 2014.

(51) Int. Cl. G06F 9/54

(52) U.S. Cl. CPC G06F 9/542

(57) ABSTRACT

Embodiments described herein relate to methods and systems for key value observing. One example embodiment accessing changes to properties of a virtual object during an event cycle. A first number of notifications for changes are also accessed during the event cycle, and changes to the properties are observed using a second number of key-value observing (KVO) instantiations. Properties are updated in a viewing level observable to a user, based on the second number of key-value observing instantiations and the various changes.

### PRIORITY CLAIM

This application claims the benefit of priority to U.S. Provisional Patent Application Ser. No. 61/979,279, filed Apr. 14, 2014, the benefit of priority of which is claimed hereby, and which is incorporated herein by reference in its entirety.

### TECHNICAL FIELD

Aspects of the present disclosures relate generally to monitoring data changes, and more particularly, but not by way of limitation, to methods and systems for key value observing.

### BACKGROUND

Key value observing (KVO) is a form of coding that allows properties of a coding object (e.g. objects in C++) to be observed when changes occur without needing to directly call or access the object's properties. For example, a data server may be notified of a change in an object's properties when a user manipulates a user interface which modifies the object's properties, even though the data server was not manually monitoring the object. Standard implementations of KVO have a number of limitations, however, and can be improved upon.

### BRIEF DESCRIPTION OF THE DRAWINGS

Various ones of the appended drawings merely illustrate example embodiments of the present disclosure and cannot be considered as limiting its scope.

FIG. 1 is a block diagram of a networked system depicting an example embodiment.

FIG. 2 illustrates a block diagrams showing components provided within the system of FIG. 1 according to some example embodiments.

FIG. 3 is a block diagram depicting an example embodiment of a client application on a client mobile device.

FIG. 4 is a flow diagram illustrating an example method for key value observing according to some embodiments.

FIG. 5 illustrates a diagrammatic representation of a machine in the form of a computer system within which a set of instructions, for causing the machine to perform any one or more of the methodologies discussed herein, may be executed, according to an example embodiment.

FIG. 6 illustrates aspects of a key value observing system according to some example embodiments.

FIG. 7 illustrates a representation of a machine having a touch-screen user interface that may be used with certain embodiments of a key value observing system.

FIG. 8 illustrates aspects of a device that may be used with certain embodiments of a key value observing system.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Example methods and systems are provided for key value observing (KVO). KVO can allow for a property of an object in a programmable language to be observed without needing to manually access the object. The property of the object may be changed or modified by a user via some user interface, and immediately a program entity managing the object may be notified of the change. Additionally, KVO allows for an efficient method for observing changes in objects from a time and resources standpoint. For example, a master model layer of an application that controls and models an application on a system-wide level need not be notified of changes to a property of an object associated with the model layer, thus saving time and energy. As another example, using traditional techniques, an application may need to be refreshed in order to view new changes to a property of an object. In contrast, using KVO, the application need not be refreshed, and the change may be updated immediately upon modification by the user.

There are other example use cases for KVO. For example, a network call may complete, returning some information to an application about a change to an application state (e.g. the user signs in, or makes a move in a turn-based game, or completes a network based transaction). The application records this new state by setting a property on a Model Object (e.g. “signedIn=true”, “TurnsCompleted=10”, “PurchasePrice=11.50”, etc.). Instead of manually informing other parts of the program that a state change has occurred that the other parts of the program might need to respond to (e.g. telling the UI to change the text on the “Sign In” button to “Sign Out”), the notifications are driven in the opposite direction: code is added in the requestor object to be told of changes instead of adding code in the object with new state to manually inform others of the new state.

Aspects of the present disclosures introduce a more efficient version of KVO including additional functionality. For example, in some example embodiments, multiple changes to a property made in rapid succession need not be updated in every single instance, unlike some current implementations of KVO. Existing implementations of KVO may respond to every change of the property, even if the changes occur hundreds of times in succession. Besides being inefficient in the sense that a user may not be able to observe every change even if it could be updated in every instance, existing implementations may experience a cyclical error if two or more of the hundreds of rapid changes depend on each other, thus causing the property to continually change in an endless cycle. In contrast, according to some example embodiments, the value of the property that is changed rapidly may be updated once a cycle or once every predetermined period. In other cases, according to some example embodiments, the endless cycle can be prevented by preventing recursive calls. This may reduce resources needlessly spent on updating a property that cannot even be observed that rapidly, and would a so eliminate the endless cycle error.

In some example embodiments, methods for KVO may also have the ability to observe who or what is observing the properties using KVO. In other words, in some example embodiments, methods may allow for observing the observers. For example, a programmer or master server may be notified when a property of an object is being observed. In other cases, objects in a model layer are observed by objects in the user interface. Such functionality may be useful so as to enable the programmer or master server to update, using, for example, KVO, only those properties that are known to be observed. For example, in a model layer that monitors and controls a vast auction application, the model layer may be notified when prices for auction items are being observed by one or more users of the auction application. Then, rather than update all prices for all auction items, the model layer need only update prices of those items that are being observed. The model layer can update the prices using KVO, rather than through more traditional methods, thus providing an efficient technique for updating the auction prices. Furthermore, because the model layer is notified when users may be observing the prices, other layers on top of the model layer, such as a control layer or a view layer, need not be notified of the changes and need not spend resources updating the prices.

Other distinguishing improvements over conventional methods may be apparent according to aspects of the present disclosure. For example, in some example embodiments, blocks are used as the vehicle to inform the observer of changes, as opposed to a single callback method that gets called for any observed change. Additional functionality of certain embodiments discussed herein may also be advantageous over other methods for KVO, including methods and systems that may be apparent based on these disclosures according to those with skill in the art.

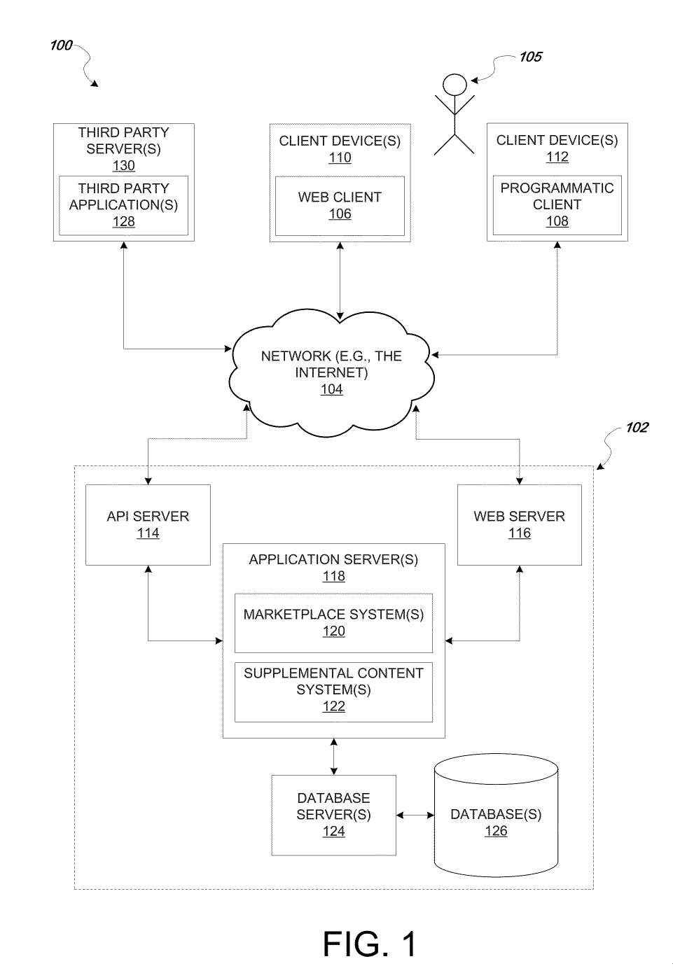

With reference to FIG. 1, an example embodiment of a high-level client-server-based network architecture 100 is shown. The network architecture 100 may include systems, applications, modules, and/or other means for utilizing aspects of the present disclosures, as may be apparent to those with skill in the art. A networked system 102, in the example forms of a network-based marketplace or payment system, provides server-side functionality via a network 104 (e.g., the Internet or wide area network (WAN)) to one or more client devices 110 and 112. FIG. 1 illustrates, for example, a web client 106 (e.g., a browser, such as the Internet Explorer® browser developed by Microsoft® Corporation of Redmond, Washington State), and a programmatic client 108 executing on respective client devices 110 and 112.

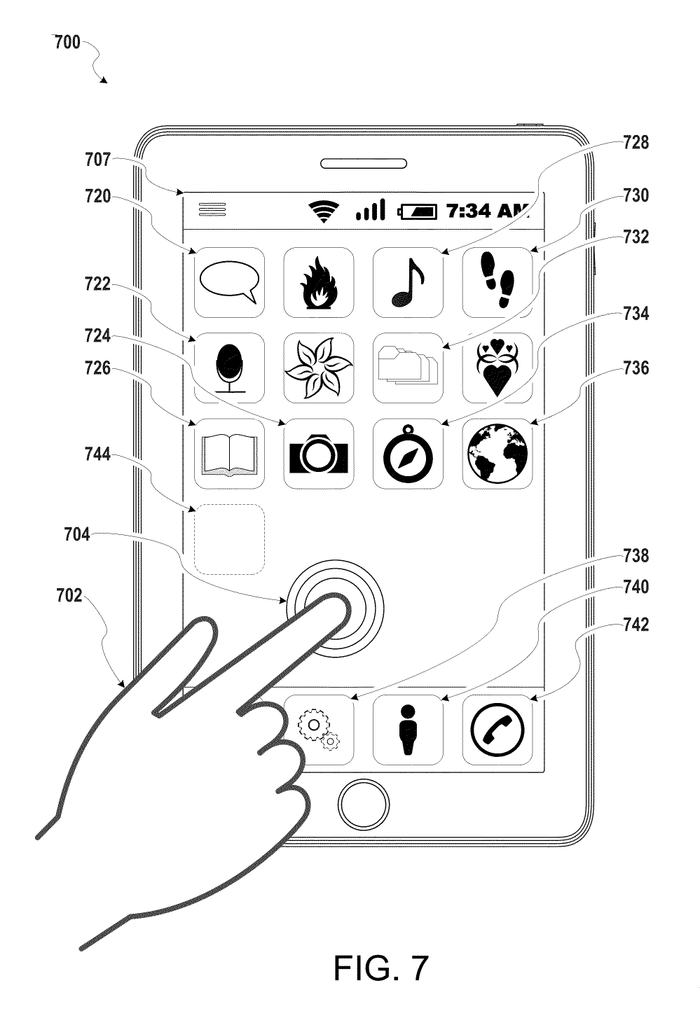

The client devices 110 and 112 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module such as the display illustrated in FIG. 7 to display information (e.g., in the form of user interfaces). In further embodiments, the client device 110 may comprise one or more of a touch screens, accelerometers, gyroscopes, cameras, microphones, global positioning system (GPS) devices, and so forth. The client devices 110 and 112 may be devices of a user that are used to access and modify properties of various objects within the networked system 102. The networked system 102 may then utilize KVO according to the presented disclosures to observe the changes being made and to update one or more aspects of one or more viewing applications for the client devices 110 and/or 112. In some examples embodiments, the networked system 102 is a network-based marketplace that responds to requests for product listings, publishes publications comprising item listings of products available on the network-based marketplace, and manages payments for these marketplace transactions. One or more users 105 may be a person, a machine, or other means of interacting with client devices 110 and 112. In embodiments, the user 105 is not part of the network architecture 100, but may interact with the network architecture 100 via client devices 110 and 112 or another means.

An application program interface (API) server 114 and a web server 116 are coupled to, and provide programmatic and web interfaces respectively to, one or more application servers 118. The application servers 118 may host one or more marketplace systems 120 and supplemental content systems 122, each of which may comprise one or more modules or applications and each of which may be embodied as hardware, software, firmware, or any combination thereof. The application servers 118 are, in turn, shown to be coupled to one or more database servers 124 that facilitate access to one or more information storage repositories or database(s) 126. In some example embodiments, the databases 126 are storage devices that store information to be posted (e.g., publications or listings) to the marketplace system 120. The databases 126 may also store digital goods information in accordance with example embodiments.

The marketplace system(s) 120 may provide a number of marketplace functions and services to users 105 that access the networked system 102. The supplemental content system 122 may likewise provide a number of functions to manage supplemental content related to digital goods, such as enabling observing of goods or other objects through KVO. While the marketplace system(s) 120 and supplemental content system(s) 122 are shown in FIG. 1 to both form part of the networked system 102, it will be appreciated that, in alternative embodiments, each system 120 and 122 may form part of a payment service that is separate and distinct from the networked system 102. In some embodiments, the supplemental content system 122 may form part of the marketplace system 120.

Further, while the client-server-based network architecture 100 shown in FIG. 1 employs a client-server architecture, the present inventive subject matter is of course not limited to such an architecture, and may equally well find application in a distributed, or peer-to-peer, architecture system, for example. The various marketplace and supplemental content systems 120 and 122 may also be implemented as standalone software programs, which do not necessarily have networking capabilities.

The web client 106 accesses the various marketplace and supplemental content systems 120 and 122 via the web interface supported by the web server 116. Similarly, the programmatic client 108 accesses the various services and functions provided by the marketplace and supplemental content system 120 and 122, respectively, via the programmatic interface provided by the API server 114. The programmatic client 108 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 108 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102. The third party server 130 may help facilitate KVO, either by representing a user who modifies changes to properties of objects, or by monitoring said changes via KVO.

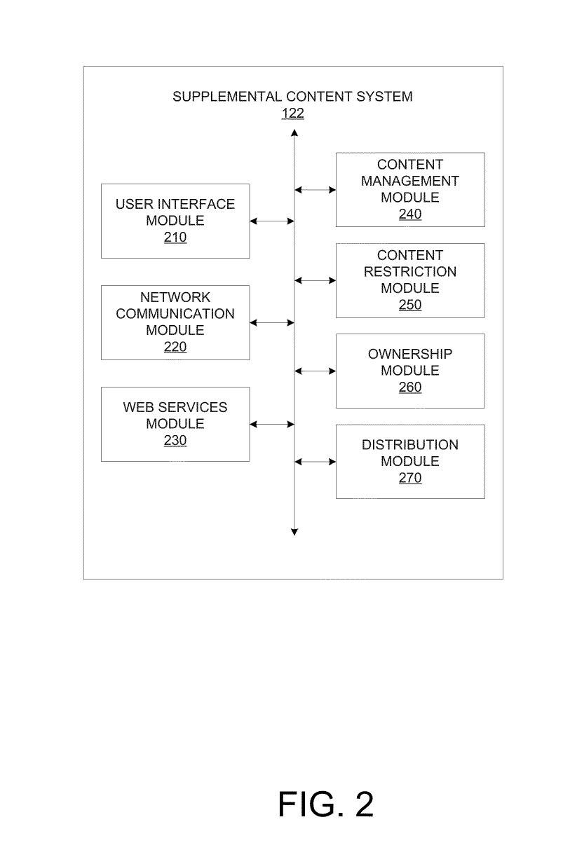

FIG. 2 is a block diagram of the supplemental content system 122, which may provide a number of functions to manage KVO. In some example embodiments, the supplemental content system 122 may include a user interface module 210, a network communication module 220, a web services module 230, a content management module 240, a content restriction module 250, an ownership module 260, and a distribution module 270. In some example embodiments, one or more of the modules may help facilitate execution of a model layer, control layer, and/or viewing layer, in order to facilitate proper handling of an application, such as an online auction application. Through the handling of the model layer, control layer, and/or the viewing layer, the modules described in MG, 2 may utilize KVO as described herein. All of the modules may communicate with each other, for example, via a network coupling, shared memory, and the like. It will be appreciated that each module may be implemented as a single module, combined into other modules, or further subdivided into multiple modules. Other modules not pertinent to example embodiments may also be included, but are not shown.

The user interface module 210 may provide various user interface functionality operable to interactively present and receive information from the user 105. For example, the user interface module 210 may provide a user interface configured to receive an input to modify a property of an Object, such as the price of an online good for sale. Information may be presented using a variety of means including visually displaying information and using other device outputs (e.g., audio, tactile, and so forth). Similarly, information may be received by a variety of means including alphanumeric input or other device input (e.g., one or more touch screen, camera, tactile sensors, light sensors, infrared sensors, biometric sensors, microphone, gyroscope, accelerometer, other sensors, and so forth). It will be appreciated that the user interface module 210 may provide many other user interfaces to facilitate functionality described herein. Presenting may mean communicating information to a device (e.g., client devices 110 and 112), the device having functionality operable to perform presentation using the communicated information. Interactively presenting may mean the exchange of information from the presenting device, the user 105, and the supplemental content system 122.

The network communication module 220 may perform various network communication functions, such as, communicating with the client devices 110 and 112 and servers, such as, the application servers 118, the database servers 124, and the third party servers 130. Network communication may operate over any wired or wireless means to provide communication functionality.

The web services module 230 may perform various web services functions such as retrieving information from third party servers 130 and application servers 118. Information retrieved by the web services module 230 may include data associated with the user 105 (e.g., user profile information from an online account, social networking data associated with the user 105, and so forth), data associated with an item (e.g., images of the item, reviews of the item, and so forth), and other data.

The content management module 240 may perform various functions to facilitate the management of the supplemental content. For example, the content management module 240 may receive the supplemental content, facilitate acquisition of the supplemental content, store the supplemental content, and provide other functionality for managing the supplemental content.

The content restriction module 250 may implement content restrictions preventing actions associated with the supplemental content. The content restrictions may include an access restriction preventing access to the supplemental content by unauthorized entities, a modification restriction preventing modification of the supplemental content, and other content restrictions. The content restriction module 250 may authorize or de-authorize entities to perform the actions corresponding to the content restrictions.

The ownership module 260 may determine ownership criteria associated with ownership rights corresponding to the supplemental content. Further actions associated with the supplemental content may be based on the determined ownership criteria. For example, the ownership module 260 may prevent the transferring of the ownership rights corresponding to the supplemental content based, in part, on the determined ownership criteria. Likewise, authorizing access to the supplemental content and other authorizations may be based, in part, on the determined ownership criteria.

The distribution module 270 may facilitate distribution of the supplemental content. For example, the distribution module 270 may cause the distribution of the supplemental content by providing a means to download, stream, access, and so forth, the supplemental content. It will be appreciated that distribution, as used herein, may mean causing distribution.

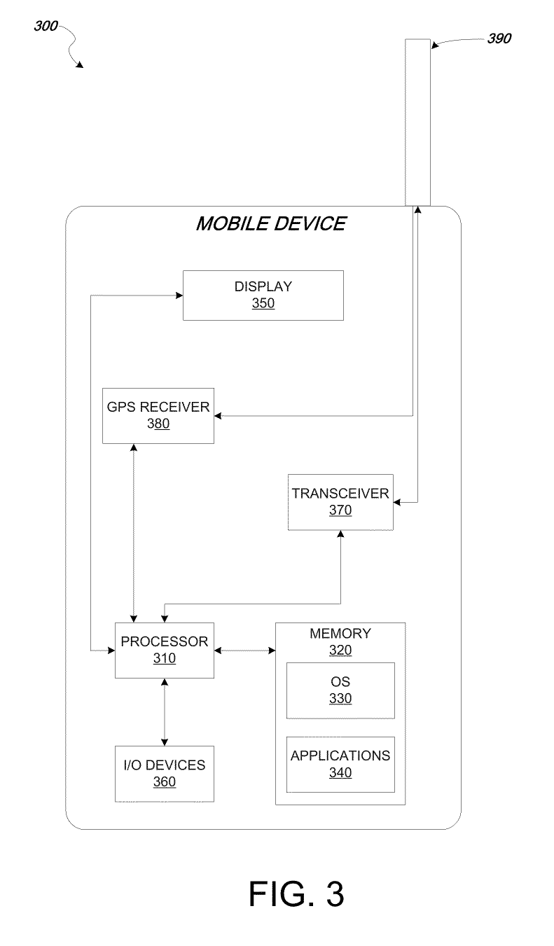

FIG. 3 is a block diagram illustrating a mobile device 300, according to some example embodiments. The mobile device 300 may be configured to utilize an application facilitated by KVO as described herein. The mobile device 300 may be configured to receive inputs from a user in order to change one or more properties of one or more objects in the application. The mobile device 300 may include a processor 310. The processor 310 may be any of a variety of different types of commercially available processors suitable for mobile devices (e.g., an XScale architecture microprocessor, a Microprocessor without Interlocked Pipeline Stages (MIPS) architecture processor, or another type of processor). A memory 320, such as a random access memory (RAM), a Flash memory, or other type of memory, is typically accessible to the processor. The memory 320 may be adapted to store an operating system (OS) 330, as well as applications 340, such as a mobile location enabled application that may provide location based services (LBSs) to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 300. In this manner, a connection with a network such as network 104 of FIG. 1 may be established. Further, in some configurations, a GPS receiver 380 may also make use of the antenna 390 to receive GPS signals.

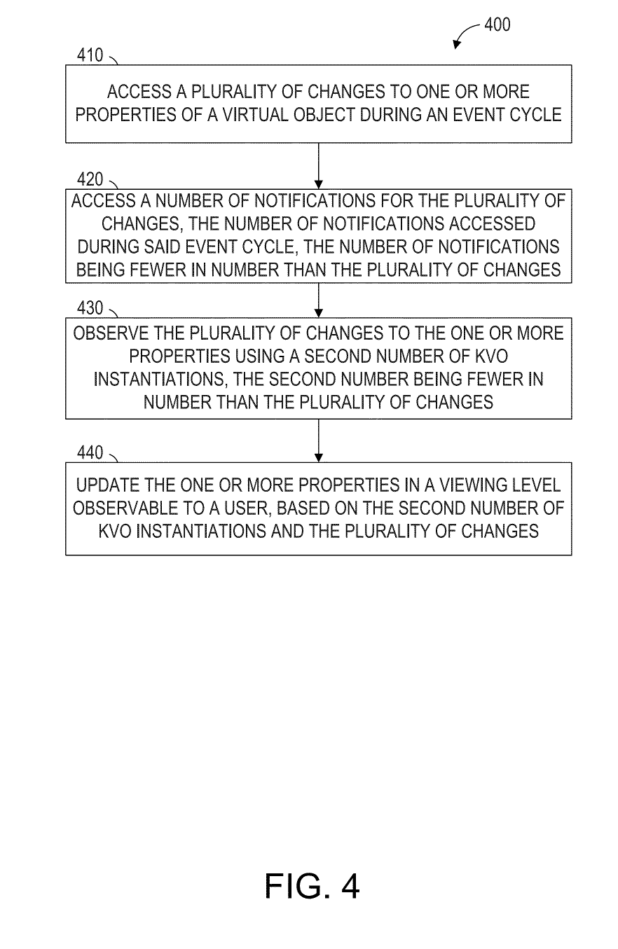

Referring to FIG. 4, an example flowchart. 400 for conducting KVO according to some example embodiments is presented. The method steps described herein may be consistent with any of the descriptions in the present disclosures. At block 410, the method may include accessing a plurality of changes to one or more properties of a virtual object during an event cycle. At block 420, the method may include accessing a first number of notifications for the plurality of changes, the first number of notifications accessed during said event cycle, the first number of notifications being fewer in number than the plurality of changes during the event cycle. At block 430, the method may include observing the plurality of changes to the one or more properties using a second number of key-value observing (KVO) instantiations, the second number of KVO instantiations being fewer in number than the plurality of changes during the event cycle. At block 440, the method may include updating the one or more properties in a viewing level observable to a user, based on the second number of key-value observing instantiations and the plurality of changes.

The following descriptions include examples for implementing KVO according to aspects of the present disclosures.

One potential KVO Example embodiment may use the following:

[modelObject tell:self when:@“aStringProperty”
changes:\hat{ }(id observingObj, id observedObj)
{
myLabel.text = observedObj.aStringProperty;
}];

In such an embodiment, the label's text will update whenever the model object's string property changes.

In some example embodiments, the implementations are designed to be much easier to use than other KVO implementations. In some example embodiments, it is also much easier to debug and about as lightweight.

Additional example embodiments may operate with certain objects. Unlike conventional 1010 implementations, in some example embodiments only subclasses of a specific base class may be observed. Making a class a subclass of some example embodiments creates a promise to the rest of the application that all publicly visible properties are KVC compliant, which may mean that the publicly visible properties use the property setter methods consistently.

Additional further embodiments may operate with certain subclasses. Rules for subclasses of some embodiments may function such that implementors need to use property setter semantics when setting properties. Such embodiments may use “object.property=x” notation or [object setProperty:x] notation in place of using object->_property=x. Internally, some embodiments may adjust selectors using method swizzling with KVO wrapper methods as necessary. Method swizzling is a process of changing the implementation of an existing selector. This is possible in certain embodiments where method invocations can be changed during system runtime by changing how selectors are mapped to underlying functions. In some example embodiments, isa-swizzling is used instead of method swizzling.

In some example embodiments, there are different methods that observe properties. Three different example embodiments that may be used in different systems to observe properties include:

(void) tell:(id) observer when:(NSString*) propertyName changes:(ObservationBlock) callBlock;

(void) tell:(id) observer whenAny:(NSArray*) propertyList changes:(ObservationBlock) callBlock;

(void) tell:(id) observer onAnyChange:(ObservationBlock) callBlock;

The first method observes a single property. The second takes an array of properties. The third observes every property of the given object. All three methods take an ObservationBlock as a parameter, which is defined as:

typedef void (̂ObservationBlock)(id observingObj, id ObserveredObj);

Inside the block, such embodiments refer to the observing and observed objects using the parameters. If such an embodiments uses self and modelObject instead, the embodiment may involve retain loop issues. Such an embodiment can create a weak self, but may also use a weak modelObject as well and, simply operate using the parameters of the system embodiment. Such embodiment may already be structured to handle retain loop issues for the system.

Unlike some conventional KVO implementations, the block arguments of certain embodiments do not inform the system what the old or new value of the property is, or even which property changed. Such embodiments can access the new value of the property directly. Other such embodiments can also set the new value of the property, or set other properties, without infinite-looping.

Another embodiment comprises an on AnyChange variant. The on AnyChange variant works by registering for every Objective-C property found in the given object and all of its superclasses. Such embodiment's works for declared properties. Embodiment methods that use set semantics but are not declared as properties are not included. Such embodiments also do not register properties found in protocols.

When an embodiment system is done observing, the operation process may conclude with various different operations. Certain embodiments may call one of these following when the Observing operation is concluded:
(void) stopTellingAboutChanges:(id) observer;
(void) stopAllCallsTo:(ObservationBlock) block;
(void) stopTelling:(id) observer aboutChangesTo:(NSString*) propertyName;
(void) stopTelling:(id) observer aboutChangesToArray:(NSArray*) propertyList;

The first method tells the observer to deregister all tells to the given observer object (that's you), and the second deregisters all tells to the given block. In embodiments where the system uses the second method, the system saves the block pointer on registration. The last two methods use a “deregister all” which interacts with object that were registered for a particular property or set of properties. If one object is registered for the same property more than once (for example, both the object and an associated superclass are registered for the same thing), all matching registrations will be removed.

In various embodiments, different operations may occur when observation blocks are called. Such operations are another difference between embodiments described herein and some other KVO implementations. In certain embodiments described herein, notification of changes is delayed until the end of the event in which the change occurred. This is done in certain embodiments so that multiple changes can be coalesced into a single observation block call. Certain such embodiments may operate where a single Observation Block will be called at most once per event loop iteration. This means that, in certain embodiments, if a property changes value multiple times in a single event, the block gets called once. If the same block is used in registering for many properties (such as the array variant), the block gets called once, even if all the properties were modified during the event.

In certain such embodiments, if an ObservationBlock sets another property when it runs (in the same or a different object), and that property is being observed as well, that property's ObservationBlock will be called only if it hasn't been called yet during this event loop iteration. The caller's ObservationBlock is called on the main thread, even if the property is set in a background thread.

Certain embodiments may then have cleanup operations that conclude an object lifetime. In certain embodiments, a system may deregister observers when the observing object deallocates. Other embodiments may operate without deregistration of observers. Unlike some conventional KVO implementations, in certain embodiments described herein, failing to deregister will not cause operation failure. Also, in certain embodiments the observers do not hold the observing object strongly. The observed object can be deallocated normally while it has registered observers. When an observed property is set, the observed object has its lifetime extended via autoreleasing until the end of the current event. This operates in some embodiments to ensure the observers are called before the observed object goes away.

ObservationBlocks themselves have a lifetime that is dependent on both the lifetime of the observed and observing objects. Observable checks that both objects still exist before calling observation blocks. If an observing object is deallocated while is has blocks registered, those blocks may not be deallocated immediately—although they'll never be called again.

Further embodiments may also operate with observers for the observers. In a system with an Observer subclass, the system can implement this operation:

(void)property:(NSString*) propNarne observationStateIs:(BOOL) isBeingObserved;

This will inform a system when properties of the system are being observed. Such an operation may be when the number of observers tier a particular property goes from 0 to 1 or 1 to 0. Additional observers for an already-observed property do not cause this method to be called. Certain embodiments may use this to dynamically decide when certain parts of an object needed to be loaded in from backing store, or requested from the network.

In some example embodiments, if a system is observing properties of some other object, the system can implement the ObservedObjectDeallocProtocol. Such a protocol operates to tell the system if an object whose properties the system is were observing has been deallocated. For example, one embodiment may operate with:

@class SubObject;
@interface BigClass
@property (strong) SubObject*subObjectThing;
end

If such a system observes a property of subObjectThing, and some system action replaces subObjectThing with a new value (that is, calls “BigClass.subObjectThing=newObjectThing;” a notification can be generated to update the observation target to observe the new subObject.

In general, a number of benefits and/or advantages according aspects of the present disclosure over conventional implementations of KVO may be apparent. For example, designing the callback model to dispatch KVO notifications in a delayed fashion may have several example benefits and/or advantages. Traditionally, KVO in Objective-C and other languages has notified observers immediately upon a change in a property's state—generally by calling observer callbacks from within the method that wraps the setter method. By using a delayed callback model, being able to request to observe many or all of the properties of an object, while having multiple changes that occur at the same time (within the same event) to be coalesced, can be advantageous. This approach can make it easy for programmers to write one piece of code that handles the case where a network call completes and every property gets updated with new info from the network packet, and is also advantageous in the case where a single property changes value due to other factors (e.g., an auction item gets marked as a Favorite, for example). It also means that the observer can know that, at the time the observer block is called, the observed object is back in a stable state again and is not halfway through being updated.

### Modules, Components, and Logic

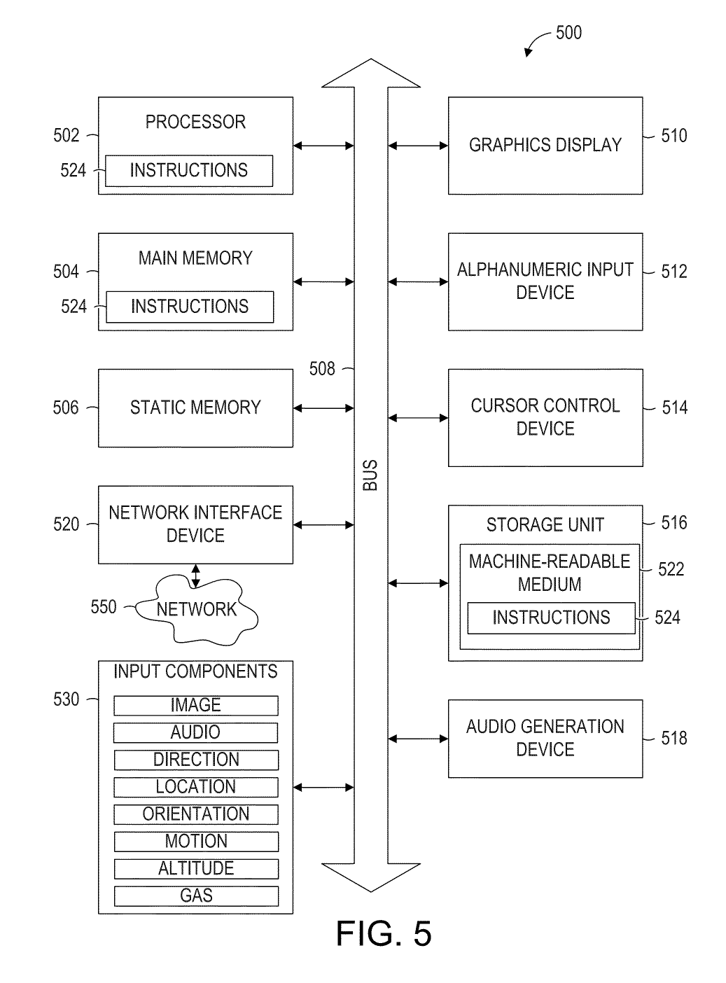

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 524 (e.g., software, a program, an application, an applet, an app, or other executable code) for causing the machine 500 to perform any one or more of the methodologies discussed herein may be executed. In alternative embodiments, the machine 500 operates as a standalone device or may be connected (e.g., networked) to other machines. In a networked deployment, the machine 500 may operate in the capacity of a server machine or a client machine in a server-client network environment, or as a peer machine in a peer-to-peer (or distributed) network environment. The machine 500 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 524, sequentially or otherwise, that specify actions to be taken by that machine. Further, while only a single machine 500 is illustrated, the term “machine” shall also be taken to include a collection of machines 500 that individually or jointly execute the instructions 524 to perform any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The machine 500 may further include a video display 510 (e.g., a plasma display panel (PDP), a light emitting diode (LED) display, a liquid crystal display (LCD), a projector, or a cathode ray tube (CRT)). The machine 500 may also include an alphanumeric input device 512 (e.g., a keyboard), a cursor control device 514 (e.g., a mouse, a touchpad, a trackball, a joystick, a motion sensor, or other pointing instrument), a storage unit 516, a signal generation device 518 (e.g., a speaker), and a network interface device 520.

The storage unit 516 includes a machine-readable medium 522 on which is stored the instructions 524 embodying any one or more of the methodologies or functions described herein. The instructions 524 may also reside, completely or at least partially, within the main memory 504, within the static memory 506, within the processor 502 (e.g., within the processor's cache memory), or both, during execution thereof by the machine 500. Accordingly, the main memory 504, static memory 506 and the processor 502 may be considered as machine-readable media 522. The instructions 524 may be transmitted or received over a network 526 via the network interface device 520.

As used herein, the term “memory” refers to a machine-readable medium 522 able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” may be taken to include a single medium or multiple media (e.g., a centralized or distributed database, or associated caches and servers) able to store instructions 524. The term “machine-readable medium” shall also be taken to include any medium, or combination of multiple media, that is capable of storing instructions (e.g., instruction 524) for execution by a machine (e.g., machine 500), such that the instructions, when executed by one or more processors of the machine 500 (e.g., processor 502), cause the machine 500 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the machine-readable medium 522 is non-transitory in that it does not embody a propagating signal. However, labeling the machine-readable medium 522 as “non-transitory” should not be construed to mean that the medium is incapable of movement; the medium should be considered as being transportable from one physical location to another. Additionally, since the machine-readable medium 522 is tangible, the medium may be considered to be a machine-readable device.

The instructions 524 may further be transmitted or received over a communications network 526 using a transmission medium via the network interface device 520 and utilizing any one of a number transfer protocols (e.g., hypertext transfer protocol (HTTP)). Examples of communication networks include a local area network (LAN), a wide area network (WAN), the Internet, mobile telephone networks, plain old telephone service (POTS) networks, and wireless data networks (e.g., Wifi, LTE, and WiMAX networks). The term “transmission medium” shall be taken to include any intangible medium that is capable of storing, encoding, or carrying instructions 524 for execution by the machine 500, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium 522 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors e.g., comprising different hardware modules) at different times. Software may accordingly configure a processor 502, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 502 that are temporarily configured (e.g., by software) or permanently configured to perform the relevant operations. Whether temporarily or permanently configured, such processors 502 may constitute processor-implemented modules that operate to perform one or more operations or functions described herein. As used herein, “processor-implemented module” refers to a hardware module implemented using one or more processors 502.

Similarly, the methods described herein may be at least partially processor-implemented, with a processor 502 being an example of hardware. For example, at least some of the operations of a method may be performed by one or more processors 502 or processor-implemented modules. Moreover, the one or more processors 502 may also operate to support performance of the relevant operations in a “cloud computing” environment or as a “software as a service” (SaaS). For example, at least some of the operations may be performed by a group of computers (as examples of machines 500 including processors 502), with these operations being accessible via a network 526 (e.g., the Internet) and via one or more appropriate interfaces (e.g., an application program interface (API)).

The performance of certain of the operations may be distributed among the one or more processors 502, not only residing within a single machine 500, but deployed across a number of machines 500. In some example embodiments, the one or more processors 502 or processor-implemented modules may be located in a single geographic location (e.g., within a home environment, an office environment, or a server farm). In other example embodiments, the one or more processors 502 or processor-implemented modules may be distributed across a number of geographic locations.

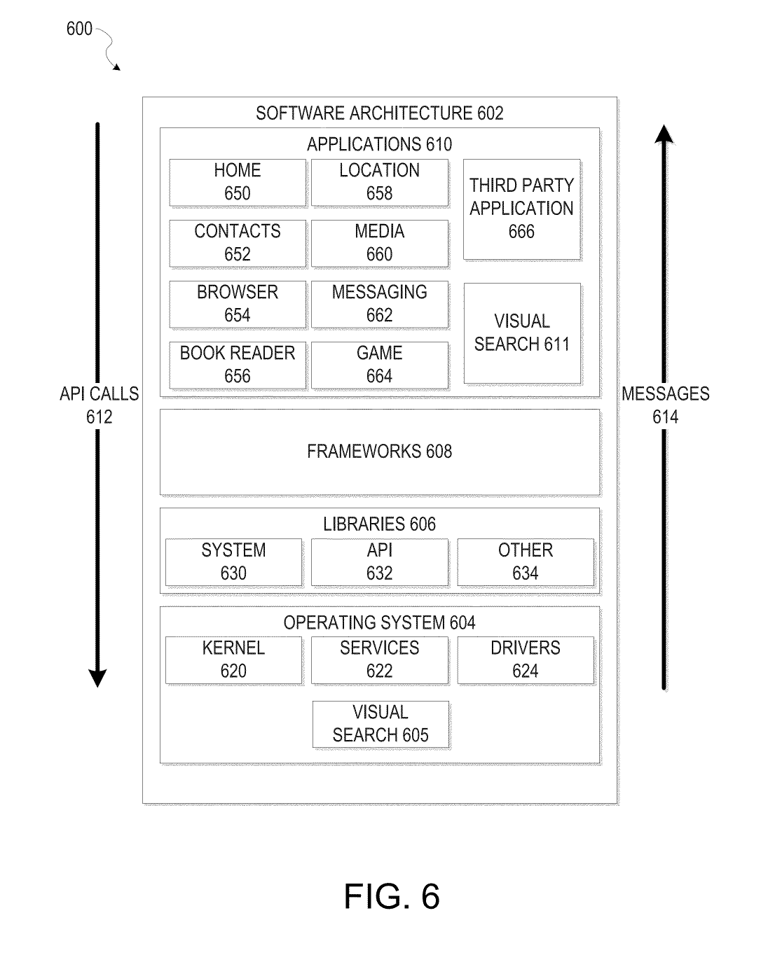

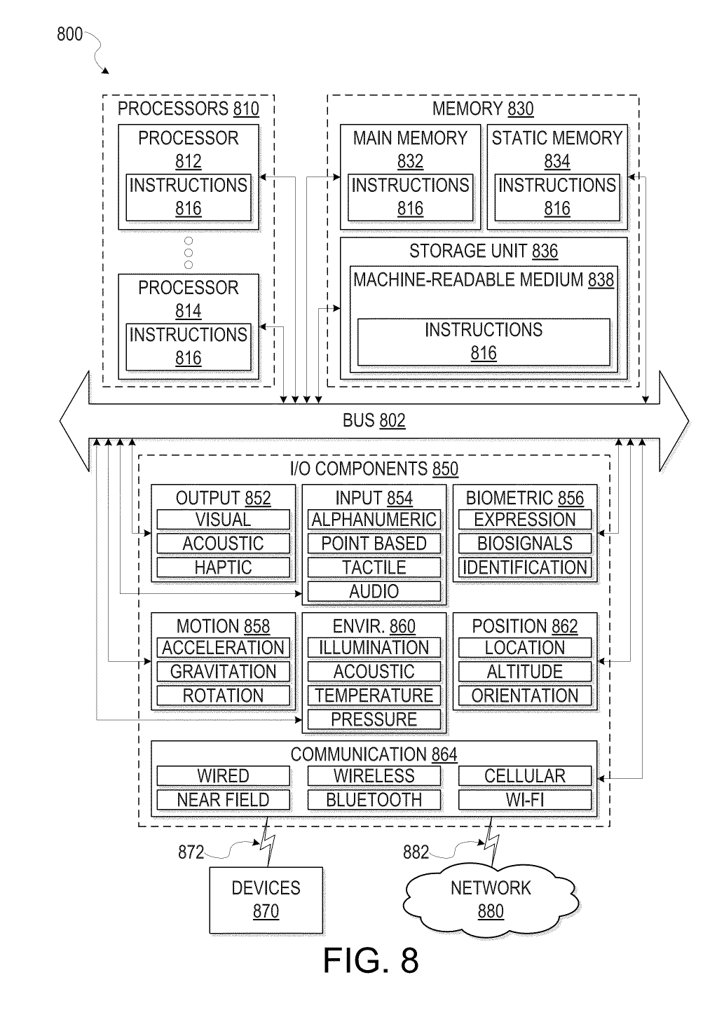

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 800 of FIG. 8 that includes, among other things, processors 810, memory 830, and I/O components 850. Executable instructions may be used to implement software architecture 602 on hardware such as machine 800, and may be used in implementation of the methods, modules and so forth of FIGS. 1-5. Hardware for software architecture 602 includes memory and/or storage modules, which also have executable instructions. A hardware layer for software architecture 602 may also comprise other hardware such as the other hardware illustrated as part of machine 800.

In the example architecture of FIG. 6, the software architecture 602 may be conceptualized as a stack of layers where each layer provides particular functionality. For example, the software architecture 602 may include layers such as an operating system 604, libraries 606, frameworks 608, applications 610 and a presentation layer. Operationally, the applications 610 and/or other components within the layers may invoke application programming interface (API) calls 612 through the software stack and receive a response, returned values, and so forth illustrated as messages 614 in response to the API calls 612. The layers illustrated are representative in nature and not all software architectures have all layers. For example, some mobile or special purpose operating systems may not provide frameworks 608, while others may provide such a layer. Other software architectures may include additional or different layers.

The operating system 604 may manage hardware resources and provide common services. The operating system 604 may include, for example, a kernel 620, services 622, and drivers 624. The kernel 620 may act as an abstraction layer between the hardware and the other software layers. For example, the kernel 620 may be responsible for memory management, processor management (e.g., scheduling), component management, networking, security settings, and so on. The services 622 may provide other common services for the other software layers. The drivers 624 may be responsible for controlling or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and an forth depending on the hardware configuration.

The libraries 606 may provide a common infrastructure that may be utilized by the applications 610 and/or other components and/or layers. The libraries 606 typically provide functionality that allows other software modules to perform tasks in an easier fashion than to interface directly with the underlying operating system 604 functionality (e.g., kernel 620, services 622 and/or drivers 624). The libraries 606 may include system libraries 630 (e.g., C standard library) that may provide functions such as memory allocation functions, string manipulation functions, mathematic functions, and the like. In addition, the libraries 606 may include API libraries such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 606 may also include a wide variety of other libraries 634 to provide many other APIs to the applications 610 and other software components/modules.

The frameworks 608 (also sometimes referred to as middleware) may provide a higher-level common infrastructure that may be utilized by the applications 610 and/or other software components/modules. For example, the frameworks 608 may provide various graphic user interface (GUI) functions, high-level resource management, high-level location services, and so forth. The frameworks 608 may provide a broad spectrum of other APIs that may be utilized by the applications 610 and/or other software components/modules, some of which may be specific to a particular operating system or platform.

The applications 610 includes built-in applications and/or third party applications 666. Examples of representative applications 610 may include, but are not limited to, a home application 650, a contacts application 652, a browser application 654, a book reader application 656, a location application 658, a media application 660, a messaging application 662, and/or a game application 664. Third party applications 666 may include any of the built-in applications as well as a broad assortment of other applications. In a specific example, the third party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In other embodiments, other operating systems such as Windows®, LINUX, MacOS, or other such desktop operating systems may also be used. In this example, the third party application 666 may invoke the API calls 612 provided by the mobile operating system such as operating system 604 to facilitate functionality described herein.

The applications 610 may utilize built-in operating system functions (e.g., kernel 620, services 622 and/or drivers 624), libraries 606 (e.g., system, APIs, and other libraries), and frameworks 608 to create user interfaces to interact with users of the system. Alternatively, or additionally, in some systems, interactions with a user may occur through a presentation layer. In these systems, the application/module “logic” can be separated from the aspects of the application/module that interact with a user.

Some software architectures utilize virtual machines. A virtual machine creates a software environment where applications/modules can execute as if they were executing on a hardware machine (such as the machine of FIG. 9, for example). A virtual machine is hosted by a host operating system (e.g., operating system 604 in FIG. 6) and typically, although not always, has a virtual machine monitor, which manages the operation of the virtual machine as well as the interface with the host operating system (i.e., operating system 604). A software architecture (e.g., software architecture 602) executes within the virtual machine such as an operating system, libraries, frameworks/middleware, applications and/or presentation layer. These layers of software architecture executing within the virtual machine can be the same as corresponding layers previously described or may be different.

FIG. 7 depicts an example mobile device and mobile operating system interface, according to some example embodiments. FIG. 7 illustrates an example mobile device 700 that may be executing a mobile operating system (e.g., iOS™, Android™, Windows® Phone, or other mobile operating systems), according to example embodiments. In certain embodiments, the software architecture 602 may be implemented on the mobile device 700 In one embodiment, the mobile device 700 may include a touchscreen that may receive tactile information from a user 702. For instance, the user 702 may physically touch 704 the mobile device 700, and in response to the touch 704, the mobile device 700 may determine tactile information such as touch location, touch force, gesture motion, and so forth. In various example embodiments, the mobile device 700 may display a home screen 706 (e.g., Springboard on iOS™) that the user 702 of the mobile device 700 may use to launch applications and otherwise manage the mobile device 700. In various example embodiments, the home screen 706 may provide status information such as battery life, connectivity, or other hardware status. The home screen 706 may also include a plurality of icons that may be activated to launch applications, for example, by touching 704 the area occupied by the icon. Similarly, other user interface elements may be activated by touching 704 an area occupied by a particular user interface element. In this manner, the user 702 may interact with the applications. In various embodiments, observations, notifications, and other updates associated with KVO operations may be presented to a device user via the example interface presented in mobile device 700. In other embodiments, other interfaces may be used.

Many varieties of applications (also referred to as “apps”) may be executing on the mobile device 700. The applications may include native applications (e.g., applications programmed in Objective-C running on iOS™ or applications programmed in Java running on Android™), mobile web applications (e.g., HTML5), or hybrid applications (e.g., a native shell application that launches HTML5 session). In a specific example, the mobile device 700 may include a messaging app 720, audio recording app 722, a camera app 724, a book reader app 726, a media app 728, a file management app 732, a location app 734, a browser app 736, a settings app 738, a contacts app 740, a telephone call app 742, other apps (e.g., gaming apps, social networking apps, biometric monitoring apps), a third party app 744, and so forth. A KVO application 730 may, in certain embodiments, be an application downloaded to the device from a server as part of system operation. The KVO application may be used as an interface for observation in conjunction with system operation. In other embodiments, KVO operation may be integrated with any of the applications described above.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described herein are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” White yet another combination produces a server computer for use within a cloud computing architecture. Not all combinations of such software and hardware architectures are presented here as those of skill in the art can readily understand how to implement the inventive subject matter in different contexts from the disclosure contained herein.

### Example Machine Arch Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example the instructions 816 may cause the machine 800 to execute any KVO operations described herein.

In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), personal digital assistant (PDA), an entertainment media system, a cellular telephone, a smart phone, a mobile device, a wearable device (e.g., a smart watch), a smart home device (e.g., a smart appliance), other smart devices, a web appliance, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an example embodiment, the processors 810 (e.g., a Central Processing Unit (CPU), a Reduced Instruction Set Computing (RISC) processor, a Complex Instruction Set Computing (CNC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include a multi-core processor that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory 830 may include a main memory 832, or other memory storage, and a storage unit 836, both accessible to the processors 810 such as via the bus 802. The storage unit 836 and main memory 832 store the instructions 816 embodying any one or more of the methodologies or functions described herein. The instructions 816 may also reside, completely or partially, within the main memory 832, within the storage unit 836, within at least one of the processors 810 (e.g., within the processor's cache memory), or any suitable combination thereof, during execution thereof by the machine 800. Accordingly, the main memory 832, the storage unit 836, and the memory of processors 810 are examples of machine-readable media.

As used herein, “machine-readable medium” means a device able to store instructions (e.g., instructions 816) and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8.

The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 850 may include biometric components 856, motion components 858, environmental components 860, or position components 862 among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a Universal Serial Bus (USB)).

Moreover, the communication components 864 may detect identifiers or include components operable to detect identifiers. For example, the communication components 864 may include Radio Frequency Identification (RFID) tag reader components, NEC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as, location via Internet Protocol (IP) geo-location, location via Wi-Fi® signal triangulation, location via detecting a NEC beacon signal that may indicate a particular location, and so forth.

### Transmission Medium

In various example embodiments, one or more portions of the network 880 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
accessing a plurality of changes to one or more properties of a virtual object during an event cycle;
accessing a first number of notifications for the plurality of changes, the first number of notifications accessed during the event cycle, the first number of notifications being fewer in number than the plurality of changes during the event cycle;
observing the plurality of changes to the one or more properties using a second number of key-value observing (KVO) instantiations, the second number of KVO instantiations being fewer in number than the plurality of changes during the event cycle; and
updating the one or more properties in a viewing level observable to a user, based on the second number of key-value Observing instantiations and the plurality of changes.

2. The method of claim 1, wherein the first number of notifications comprises at most one notification.

3. The method of claim 1 wherein each KVO instantiation is associated with a label.

4. The method of claim 1 wherein the label comprises a string variable, and wherein text associated with the string variable is updated based on a first change of the plurality of changes to the one or more properties.

5. The method of claim 1 wherein the one or more properties comprises a subclass of properties, such that only subclasses of a base class are observed.

6. The method of claim 1 wherein the one or more properties of the virtual object consist of all properties of the virtual object.

7. The method of claim 1 further comprising:
determining that the virtual object has been deallocated; and
automatically deallocating associated KVO instantiations.

8. The method of claim 1 further comprising:
observing changes in property observation using an observer subclass.

9. The method of claim 8 further comprising:
generating a notification when a number of observers for a particular property changes from 0, the notification indicating that the property is under observation.

10. The method of claim 8 further comprising:
generating a notification when a number of observers for a particular property changes to 0, the notification indicating that the property is not under observation.

11. A device comprising:
a memory; and
at least one processor coupled to the memory, the at least one processor configured to:
access a plurality of changes to one or more properties of a virtual object during an event cycle;
access a first number of notifications for the plurality of changes, the first number of notifications accessed during the event cycle, the first number of notifications being fewer in number than the plurality of changes during the event cycle;
observe the plurality of changes to the one or more properties using a second number of key-value observing (KVO) instantiations, the second number of KVO instantiations being fewer in number than the plurality of changes during the event cycle; and
update the one or more properties in a viewing level observable to a user, based on the second number of key-value observing instantiations and the plurality of changes.

12. The device of claim 11, wherein the first number of notifications comprises at most one notification.

13. The device of claim 11, wherein the second number of KVO instantiations comprises one KVO instantiation.

14. The device of claim 11, wherein each KVO instantiation is associated with a label.

15. The device of claim 11, wherein the label comprises a string variable, and wherein text associated with the string variable is updated based on a first change of the plurality of changes to the one or more properties.

16. The device of claim 11, wherein the one or more properties comprises a subclass of properties, such that only subclasses of a base class are observed.

17. A non-transitory computer readable medium comprising instructions that, when executed by one or more processors, cause a system to: access a plurality of changes to one or more properties of a virtual object during an event cycle;
access a first number of notifications fir the plurality of changes, the first number of notifications accessed during the event cycle, the first number of notifications being fewer in number than the plurality of changes during the event cycle;
observe the plurality of changes to the one or more properties using a second number of key-value observing (KVO) instantiations, the second number of KVO instantiations being fewer in number than the plurality of changes during the event cycle; and
update the one or more properties in a viewing level observable to a user, based on the second number of key-value observing instantiations and the plurality of changes.

18. The non-transitory computer readable medium of claim 17 wherein the instructions further cause the one or more processors to:
determine that the virtual object has been deallocated; and
automatically deallocate associated KVO instantiations.

19. The non-transitory computer readable medium of claim 17 wherein the instructions further cause the one or more processors to:
observe changes in property observation using an Observer subclass.

20. The non-transitory computer readable medium of claim 17 wherein the instructions further cause the one or more processors to:
generate a notification when a number of observers for a particular property changes from 0, the notification indicating that the property is under observation.
